(19) United States
(12) Patent Application Publication
(10) Pub. No.: US 2012/0296458 A1
(43) Pub. Date: Nov. 22, 2012

(54) Background Audio Listening for Content Recognition

(75) Inventors: Kazuhito Koishida, Redmond, WA (US); David Nister, Bellevue, WA (US); Ian Simon, Seattle, WA (US); Tom Butcher, Seattle, WA (US)

(73) Assignee: Microsoft Corporation, Redmond, WA (US)

(21) Appl. No.: 13/110,168

(22) Filed: May 18, 2011

(51) Int. Cl. G06F 17/00

(52) U.S. Cl. 700/94

(57) ABSTRACT

Various embodiments enable audio data, such as music data, to be captured, by a device, from a background environment and processed to formulate a query that can then be transmitted to a content recognition service. In one or more embodiments, the audio data is captured prior to receiving user input associated with audio data capture, e.g., launch of an application associated with the content recognition service, provision of user input proactively indicating that audio data capture is desired, and the like. Responsive to transmitting the query, displayable information associated with the audio data is returned by the content recognition service and can be consumed by the device.

### BACKGROUND

Music recognition programs traditionally operate by capturing audio data using device microphones and submitting queries to a server that includes a searchable database. The server is then able to search its database, using the audio data, for information associated with the content from which the audio data was captured. Such information can then be returned for consumption by the device that sent the query.

Users initiate the audio capture by launching an associated audio-capturing application on their device and interacting with the application, such as by providing user input that tells the application to begin capturing audio data. However, because of the time that it takes for a user to pick up her device, interact with the device to launch the application, capture the audio data and query the database, associated information is not returned from the server to the device until after a long period of time, e.g., 12 seconds or longer. This can lead to an undesirable user experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments enable audio data, such as music data, to be captured by a device, from a background environment and processed to formulate a query that can then be transmitted to a content recognition service. In one or more embodiments, the audio data is captured prior to receiving user input associated with audio data capture, e.g., launch of an executable module associated with the content recognition service, provision of user input proactively indicating that audio data capture is desired, and the like. Responsive to transmitting the query, displayable information associated with the audio data is returned by the content recognition service and can be consumed by the device.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 is an illustration of an example environment in accordance with one or more embodiments;

FIG. 2 illustrates a background listening module and content recognition executable module in accordance with one or more embodiments;

FIG. 3 depicts a timeline of an example implementation that describes audio data capture in accordance with one or more embodiments;

FIG. 4 is a flow diagram that describes steps in a method in accordance with one or more embodiments;

FIG. 5 is a flow diagram that describes steps in a method in accordance with one or more embodiments;

FIG. 6 is a flow diagram that describes steps in a method in accordance with one or more embodiments;

FIG. 7 illustrates one embodiment of content recognition executable module;

FIG. 8 is a flow diagram that describes steps in a method in accordance with one or more embodiments; and

FIG. 9 illustrates an example client device that can be utilized to implement one or more embodiments.

### DETAILED DESCRIPTION

Overview

Various embodiments enable audio data, such as music data, to be captured, by a device, from a background environment and processed to formulate a query that can then be transmitted to a content recognition service. In one or more embodiments, the audio data is captured prior to receiving user input associated with audio data capture, e.g., launch of an executable module associated with the content recognition service, provision of user input proactively indicating that audio data capture is desired, and the like. Responsive to transmitting the query, displayable information associated with the audio data is returned by the content recognition service and can be consumed by the device.

In at least some embodiments, by capturing audio data prior to receiving user input associated with audio data capture, client-side latencies associated with query formulation can be reduced and results can be returned more quickly to the client device, as will become apparent below.

In the discussion that follows, a section entitled “Example Operating Environment” describes an operating environment in accordance with one or more embodiments. Next, a section entitled “Example Embodiment” describes various embodiments of a content recognition executable module associated with a content recognition service. In particular, the section describes audio capture in accordance with one or more embodiments. Next, a section entitled “Feature Extraction Module” describes an example feature extraction module in accordance with one or more embodiments.

In a section entitled “Example Content Recognition Service,” a content recognition service in accordance with one or more embodiments is described. Finally, a section entitled “Example System” describes a mobile device in accordance with one or more embodiments.

Consider, now, an example operating environment in accordance with one or more embodiments.

Example Operating Environment

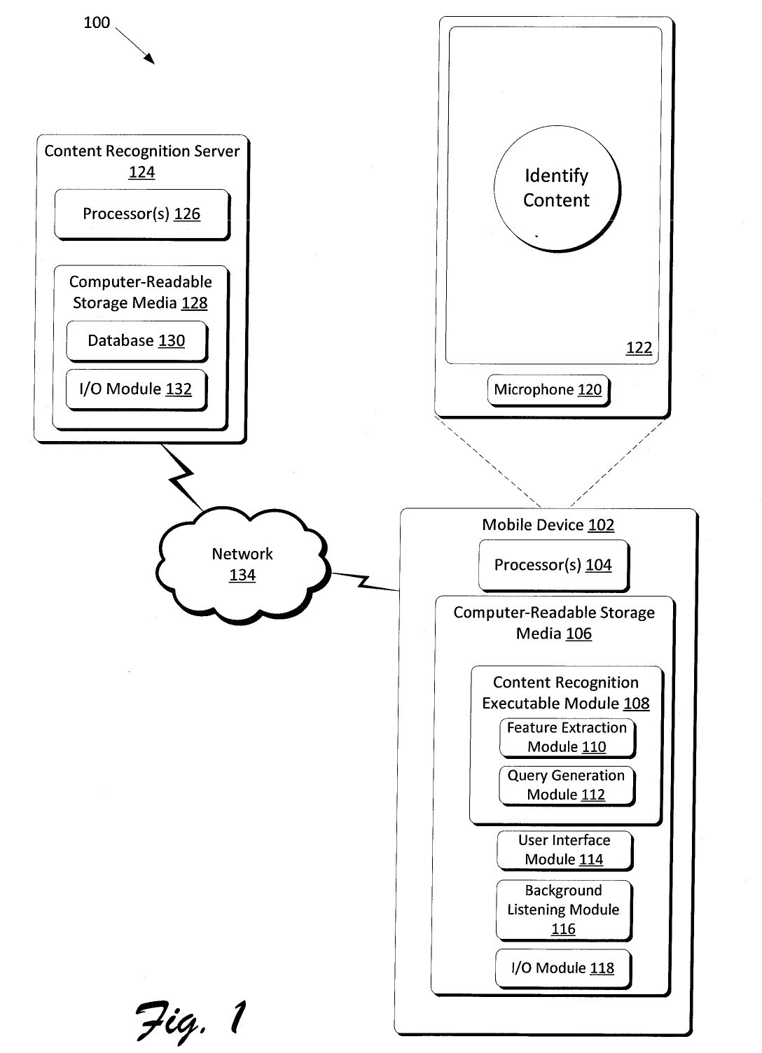

FIG. 1 is an illustration of an example environment 100 in accordance with one or more embodiments. Environment 100 includes a client device in the form of a mobile device 102 that is configured to capture audio data for provision to a content recognition service, as will be described below. The client device can be implemented as any suitable type of device, such as a mobile device (e.g., a mobile phone, portable music player, personal digital assistants, dedicated messaging devices, portable game devices, netbooks, tablets, and the like).

In the illustrated and described embodiment, mobile device 102 includes one or more processors 104 and computer-readable storage media 106. Computer-readable storage media 106 includes a content recognition executable module 108 which, in turn, includes a feature extraction module 110 and a query generation module 112. The computer-readable storage media also includes a user interface module 114 which manages user interfaces associated with executable modules that execute on the device, a background listening module 116, and an input/output module 118. Mobile device 102 also includes one or more microphones 120, and a display 122 that is configured to display content.

Environment 100 also includes one or more content recognition servers 124. Individual content recognition servers include one or more processors 126, computer-readable storage media 128, one or more databases 130, and an input/output module 132.

Environment 100 also includes a network 134 over which mobile device 102 and content recognition server 124 communicate. Any suitable network can be employed such as, by way of example and not limitation, the Internet.

Display 122 may be used to output a variety of content, such as a caller identification (ID), contacts, images (e.g., photos), email, multimedia messages, Internet browsing content, game play content, music, video and so on. In one or more embodiments, the display 122 is configured to function as an input device by incorporating touchscreen functionality, e.g., through capacitive, surface acoustic wave, resistive, optical, strain gauge, dispersive signals, acoustic pulse, and other touchscreen functionality. The touchscreen functionality (as well as other functionality such as track pads) may also be used to detect gestures or other input.

The microphone 120 is representative of functionality that captures audio data so that background listening module 116 can store the captured audio data in a buffer prior to receiving user input associated with audio data capture, as will be described in more detail below. In one or more embodiments, when user input is received indicating that audio data capture is desired, the captured audio data can be processed by the content recognition executable module 108 and, more specifically, the feature extraction module 110 extracts features, as described below, that are then used to formulate a query, via query generation module 112. The formulated query can then be transmitted to the content recognition server 124 by way of the input/output module 118.

The input/output module 118 communicates via network 134, e.g., to submit the queries to a server and to receive displayable information from the server. The input/output module 118 may also include a variety of other functionality, such as functionality to make and receive telephone calls, form short message service (SMS) text messages, multimedia messaging service (MMS) messages, emails, status updates to be communicated to a social network service, and so on. In the illustrated and described embodiment, user interface module 114 can, under the influence of content recognition executable module 108, cause a user interface instrumentality—here designated “Identify Content”—to be presented to user so that the user can indicate, to the content recognition executable module, that audio data capture is desired. For example, the user may be in a shopping mall and hear a particular song that they like. Responsive to hearing the song, the user can launch or execute the content recognition executable module 108 and provide input of via the “Identify Content” instrumentality that is presented on the device. Such input indicates to the content recognition executable module 108 that audio data capture is desired and that additional information associated with the audio data is to be requested. The content recognition executable module can then extract features from the captured audio data as described above and below, and use the query generation module to generate a query packet that can then be sent to the content recognition server 124.

Content recognition server 124, through input/output module 132, can then receive the query packet via network 134 and search its database 130 for information associated with a song that corresponds to the extracted features contained in the query packet. Such information can include, by way of example and not limitation, displayable information such as song titles, artists, album titles, lyrics and other information. This information can then be returned to the mobile device 102 so that it can be displayed on display 122 for a user.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable memory devices. The features of the user interface techniques described below are platform-independent, meaning that the techniques may be implemented on a variety of commercial computing platforms having a variety of processors.

Example Embodiment

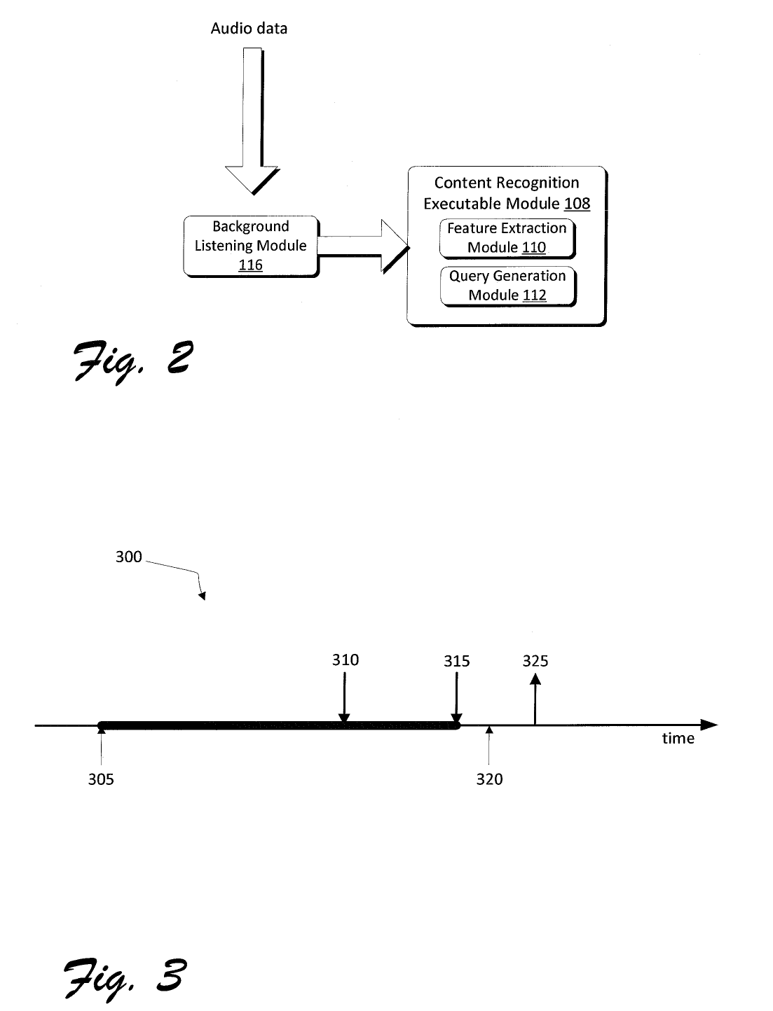

FIG. 2 illustrates background listening module 116 and content recognition executable module 108 in accordance with one or more embodiments. In operation, audio data, at least some of which is processable for provision to a content recognition service, is captured with microphone 120 of mobile device 102 (as shown on FIG. 1). Audio data can be captured in other ways, depending on the specific implementation. For example, the audio data can be captured from a streaming source, such as an FM or HD radio signal stream. Background listening module 116 stores or pre-buffers the audio data in a buffer. In one or more embodiments, the audio data is pre-buffered prior to receiving user input associated with audio data capture. Specifically, before user input is received that indicates or is suggested that particular content is to become the subject of a query to a content recognition service, the audio data is captured and buffered. This helps to reduce the latency between when a user indicates that content recognition services are desired and the time a query is sent to the content recognition service.

For example, background listening can occur at or during a number of different times. For example, background listening can be activated at times when a device is active and not in a power-saving mode, e.g., when being carried by a user. Alternately or additionally, background listening can be activated during a user's interaction with the mobile device, such as when a user is sending a text or email message. Alternately or additionally, background listening can be activated while a client executable module, such as content recognition executable module 108, is running or at executable module start up.

In one or more battery-saving embodiments, processing overhead is reduced during background listening by simply capturing and buffering the audio data, and not extracting features from the data. The buffer can be configured to maintain a fixed amount of audio data in order to make efficient use of the device's memory resources. Once a request for information regarding the audio data, also sometimes referred to herein as content information, is selected via the user instrumentality, most recently-captured audio data can be obtained from the buffer and processed by the content recognition executable module 108. More specifically, assume a user selects an “Identify Content” instrumentality on the display 122. In response, the feature extraction module 110 processes the audio data and extracts features as described above and below. One specific implementation of a feature extraction module is described below under the heading “Example Feature Extraction Module.” The extracted features are then processed by the query generation module 112 which accumulates the extracted features to formulate a query and generates a query packet for transmission to the content recognition server 124.

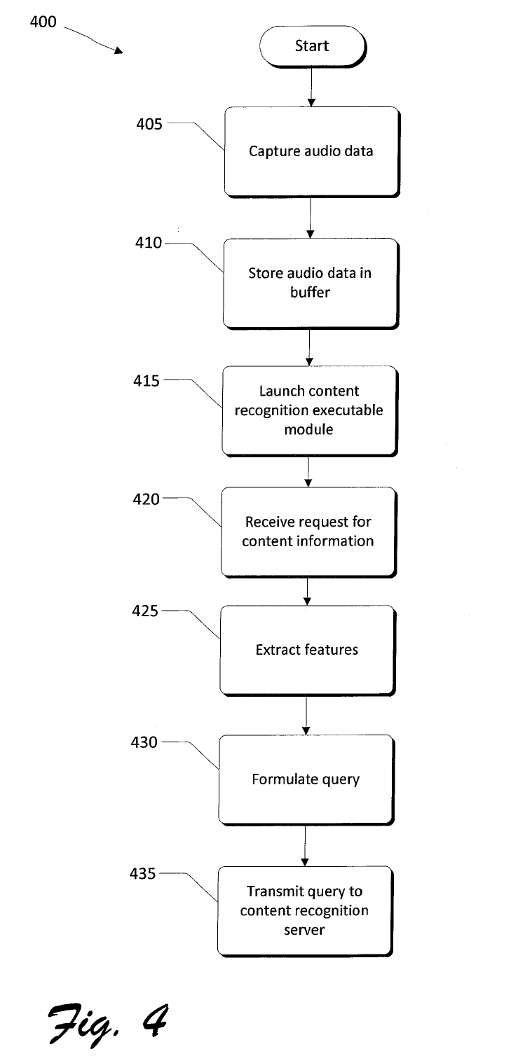

As an example of how background listening can occur in accordance with one or more embodiments, consider FIG. 3.

FIG. 3 depicts a timeline 300 of an example implementation that describes audio data capture in accordance with one or more embodiments.

In this timeline, the dark black line represents time during which audio data is captured by the device. There are a number of different points of interest along the timeline. For example, point 305 depicts the beginning of audio data capture in one or more scenarios, point 310 depicts the launch of content recognition executable module 108, point 315 depicts a user interaction with a user instrumentality, such as the “Identify Content” tab or button, point 320 depicts the time at which a query is transmitted to the content recognition server, and point 325 depicts the time at which content returned from the content recognition server is displayed on the device.

In one or more embodiments, point 305 can be associated with different scenarios that initiate the beginning of audio capture. For example, point 305 can be associated with activation of a device, e.g., when the device is turned on or brought out of standby mode. Alternately or additionally, point 305 can be associated with a user's interaction with the mobile device, such as when the user picks up the device, sends a text or email message, and the like. For example, a user may be sitting in a café and have the device sitting on the table. While the device is motionless, it may not, in some embodiments, be capturing audio data. However, the device can begin to capture audio data when the device is picked up, when the device is turned on, or when the device is not in a standby mode. Further, in some embodiments, the device can capture audio data beginning when the user initiates an executable module, such as a mobile browser or text messaging executable module. At point 310, the user launches the content recognition executable module 108. For example, the user may hear a song in the café and would like information on the song, such as the title and artist of the song. After launching the content recognition executable module, the user interacts with a user instrumentality, such as the “Identify Content” tab or button at point 315 and at point 320 a query is transmitted to the content recognition server. At point 325, content is returned from the content recognition server and displayed on the device. Note that the time between points 315, 320 depicts the time during which feature extraction, query formulation and query transmission occurs, as will be described below. Because audio data has been captured in the background prior to the user indicating a desire to receive information or content associated with a song, the time consumed by this process has been dramatically reduced, thereby enhancing the user's experience.

In one or more other embodiments, audio data capture can occur starting at point 310 when a user launches content recognition executable module 108. For example, a user may be walking through a shopping mall, hear a song, and launch the content recognition executable module. By launching the content recognition executable module, the device may infer that the user is interested in obtaining information about the song. Thus, by initiating audio data capture when the content recognition executable module is launched, additional audio data can be captured as compared to scenarios in which audio data capture initiates when the user actually indicates to the device that she is interested in obtaining information about the song via the user instrumentality. Processing in this case would proceed as described above with respect to points 315, 320 and 325. Again, efficiencies are achieved and the user experience is enhanced because the time utilized to formulate a query and receive back results is dramatically reduced.

Having described an example timeline that illustrates a number of different audio capture scenarios, consider now a discussion of example methods in accordance with one or more embodiments.

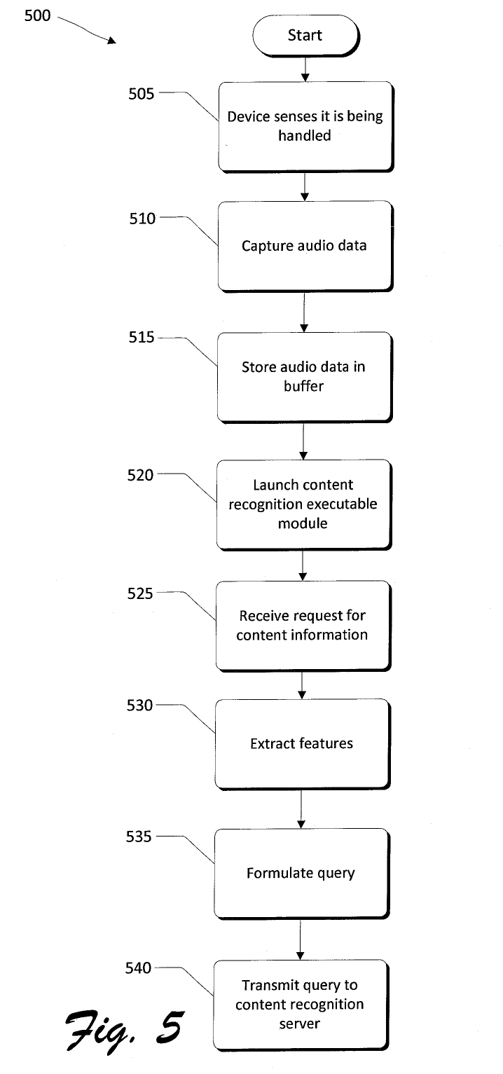

FIG. 4 is a flow diagram that describes steps in a method 400 in accordance with one or more embodiments. The method can be implemented in connection with any suitable hardware, software, firmware, or combination thereof. In at least some embodiments, the method can be implemented by a client device, such as a mobile device, examples of which are provided above.

At block 405, the mobile device captures audio data. This can be performed in any suitable way. For example, the audio data can be captured from a streaming source, such as an FM or HD radio signal stream. The capture of audio data can be initiated by a number of different events. For example, audio data can be captured when the mobile device is initially turned on from, for example, an “off” or “standby” state. For example, an operating system of the mobile device can include code executed to cause the device to continuously capture audio data in the background. At block 410, the device stores audio data in a buffer. This can be performed in any suitable way and can utilize any suitable buffer and/or buffering techniques. At block 415, the device launches a content recognition executable module. This can be performed in any suitable way. For example, the mobile device can receive input from a user, such as by a user selecting an icon representing the content recognition executable module. At block 420, the device receives a request for content information associated with audio data that has been captured. This can be performed in any suitable way, examples of which are provided above. Responsive to receiving the request for content information, at block 425, the device extracts features associated with the audio data. Examples of how this can be done are provided above and below. The device formulates a query at block 430 using features that were extracted in block 425. This can be performed in any suitable way. At block 435, the device transmits the query to a content recognition server for processing by the server. Examples of how this can be done are provided below.

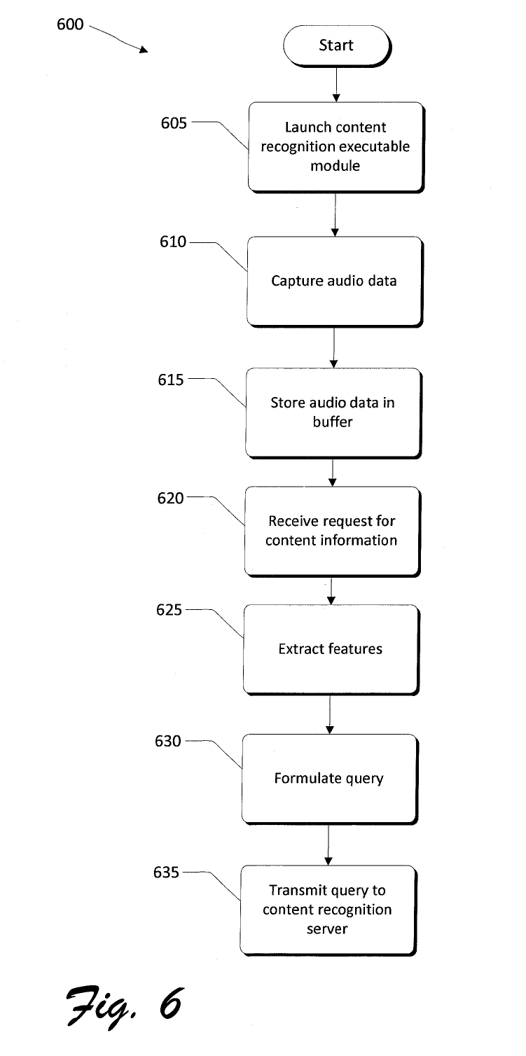

FIG. 5 is a flow diagram that describes steps in a method 500 in accordance with one or more embodiments. The method can be implemented in connection with any suitable hardware, software, firmware, or combination thereof. In at least some embodiments, the method can be implemented by a client device, such as a mobile device, examples of which are provided above.

At block 505, the device senses that it is being handled in some manner. For example, the device may sense that it has been picked up or that the user is interacting with device hardware (e.g., a touchscreen) or device software (e.g., a text message program or email program). Responsive to sensing that it is being handled, at block 510, the device captures audio data. This can be performed in any suitable way. For example, the audio data can be captured from a streaming source, such as an FM or HD radio signal stream. At block 515, the device stores audio data in a buffer. This can be performed in any suitable way and can utilize any suitable buffer and/or buffering techniques. The device launches a content recognition executable module at block 520. This can be performed in any suitable way. For example, the mobile device can receive input from a user; such as when a user selects an icon representing the content recognition executable module. At block 525, the device receives a request for content information associated with audio data that has been captured. This can be performed in any suitable way, examples of which are provided above. Responsive to receiving the request for content information, at block 530, the device extracts features associated with the audio data. Examples of how this can be done are provided above and below. At block 535, the device formulates a query using features that were extracted in block 530. This can be performed in any suitable way. At block 540, the device transmits the query to a content recognition server for processing by the server. Examples of how this can be done are provided below.

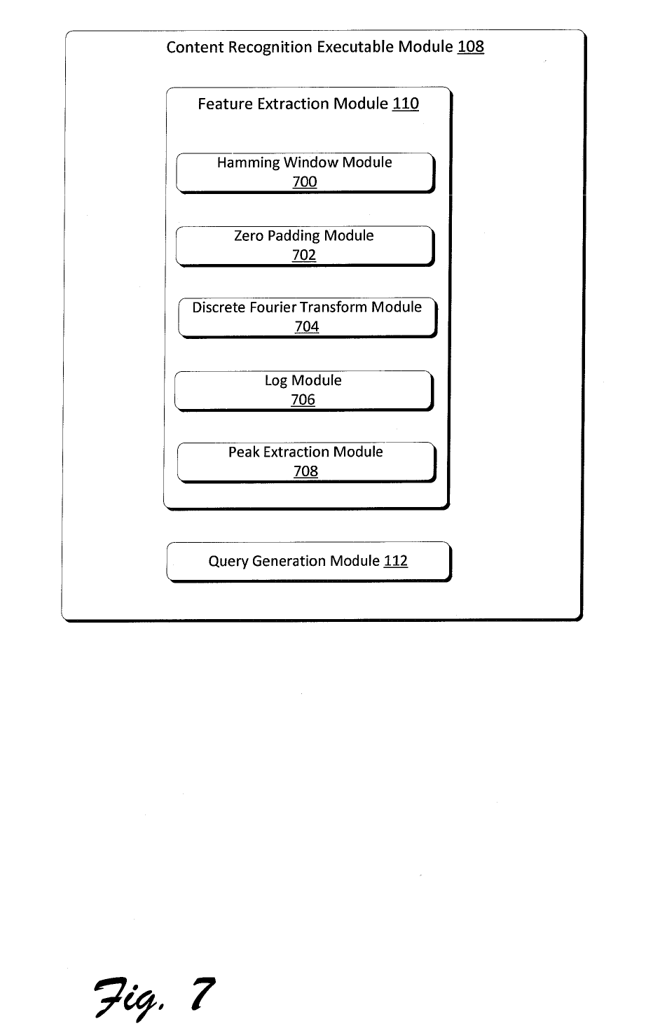

FIG. 6 is a flow diagram that describes steps in a method 600 in accordance with one or more embodiments. The method can be implemented in connection with any suitable hardware, software, firmware, or combination thereof. In at least some embodiments, the method can be implemented by a client device, such as a mobile device, examples of which are provided above.

At block 605, the device launches a content recognition executable module. This can be performed in any suitable way. For example, the mobile device receives input from a user, such as when a user selects an icon representing the content recognition executable module. At block 610, the device captures audio data. This can be performed in any suitable way. For example, capture of audio data can be initiated by a user interacting with an executable module on the device, such as the content recognition executable module. At block 615, the device stores audio data in a buffer. This can be performed in any suitable way and can utilize any suitable buffer and/or buffering techniques. At block 620, the device receives a request for content information associated with audio data that has been captured. This can be performed in any suitable way, examples of which are provided above. Responsive to receiving the request for content information, at block 625, the device extracts features associated with the audio data. Examples of how this can be done are provided above and below. At block 630, the device formulates a query using features that were extracted in block 625. This can be performed in any suitable way. At block 635, the device transmits the query to a content recognition server for processing by the server. Examples of how this can be done are provided below.

Having described example methods in accordance with one or more embodiments, consider now a discussion of an example feature extraction module in accordance with one or more embodiments.

Feature Extraction Module

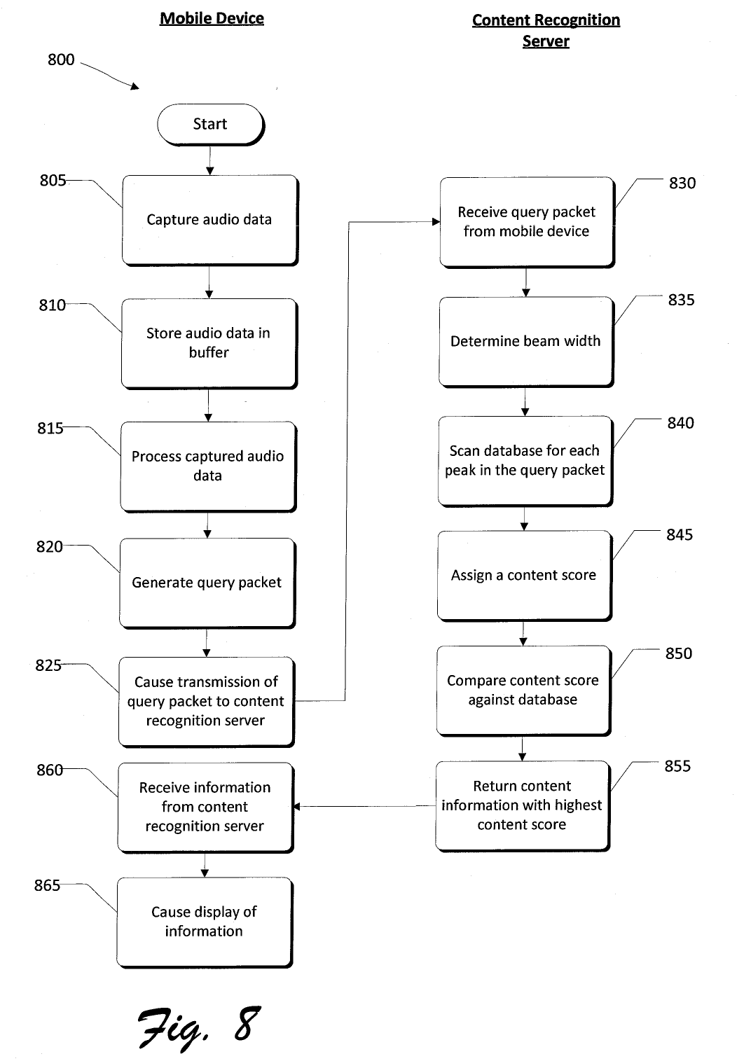

FIG. 7 illustrates one embodiment of content recognition executable module 108. In this example, feature extraction module 110 is configured to process captured audio data using spectral peak analysis so that query generation module 112 can formulate a query packet for provision to content recognition server 124 (FIG. 1) as described below. In the illustrated and described embodiment, the processing performed by feature extraction module 110 can be performed responsive to various requests for content information. For example, a user can select a user instrumentality (such as the “Identify Content” button) on the display of the device.

Any suitable type of feature extraction can be performed without departing from the spirit and scope of the claimed subject matter. In this particular example, feature extraction module 110 includes a Hamming window module 700, a zero padding module 702, a discrete Fourier transform module 704, a log module 706, and a peak extraction module 708. As noted above, the feature extraction module 110 processes audio data in the form of audio samples received from the buffer in which the samples are stored. Any suitable quantity of audio samples can be processed out of the buffer. For example, in some embodiments, a block of 128 ms of audio data (1024 samples) are obtained from a new time position shifted by 20 ms. The Hamming window module 700 applies a Hamming window to the signal block. The Hamming window can be represented by an equation

$$w ( n ) = 0.54 - 0.46 cos ( \frac{2 π n}{N - 1} )$$

where N represents the width in samples (N=1024) and n is an integer between zero and N−1.

Zero padding module 702 pads the 1024-sample signal with zeros to produce a 8192-sample signal. The use of zero-padding can effectively produce improved frequency resolution in the FFT spectrum at little or even no expense of the time resolution.

The discrete Fourier transform module 704 computes the discrete Fourier transform (DFT) on the zero-padded signals to produce a 4096-bin spectrum. This can be accomplished in any suitable way. For example, the discrete Fourier transform module 704 can employ a fast Fourier transform algorithm e.g., the split-radix FFT or another FFT algorithm. The DFT can be represented by an equation

$${X}_{k} = {\sum }_{n = 0}^{N - 1} {x}_{n} {ω}_{N}^{nk}$$

where xₙ is the input signal and Xₖ is the output. N is an integer (N=8192) and k is greater to or equal to zero, and less than N/2 (0≦k<N/2).

Log module 706 applies the power of DFT spectrum to yield the time-frequency log-power spectrum. The log-power can be represented by an equation

Sₖ=log(|Xₖ|²)

where Xₖ is the output from the discrete Fourier transform module 704.

From the resulting time-frequency spectrum, peak extraction module 708 extracts spectral peaks as audio features in such a way that they are distributed widely over time and frequency.

In some embodiments, the zero-padded DFT can be replaced with a smaller-sized zero-padded DFT followed by an interpolation to reduce the computational burden on the device. In such embodiments, the audio data is zero-padded DFT with 2× up-sampling to produce a 1024-bin spectrum and passed through a Lancozos resampling filter to obtain the interpolated 4096-bin spectrum (4× up-sampling).

Once the peak extraction module extracts the spectral peaks as described above, the query generation module can use extracted spectral peaks to formulate a query packet which can then be transmitted to the content recognition service.

Having described an example content recognition executable module in accordance with one or more embodiments, consider now a discussion of an example content recognition service in accordance with one or more embodiments.

Example Content Recognition Service

The content recognition service stores searchable information associated with songs and other content (e.g., movies) that can enable the service to identify a particular song or content item from information that it receives in a query packet. Any suitable type of searchable information can be used. In the present example, this searchable information includes, by way of example and not limitation, peak information such as spectral peak information associated with a number of different songs.

In this particular implementation example, peak information (indexes of time/frequency locations) for each song is sorted by a frequency index and stored into a searchable fingerprint database. In the illustrated and described embodiment, the database is structured such that each frequency index carries a list of corresponding time positions. A “best matched” song is identified by a linear scan of the fingerprint database. That is, for a given query peak, a list of time positions at the frequency index is retrieved and scores at the time differences between the database and query peaks are incremented. The procedure is repeated over all the query peaks and the highest score is considered as a song score. The song scores are compared against the whole database and the song identifier or ID with the highest song score is returned.

In some embodiments, beam searching can be used. In beam searching, the retrieval of the time positions is performed in a range starting from B_{L} below to B_{H} above. The beam width “B” is defined as

B=B_{L}+B_{H}+1

Search complexity is a function of B—that is, the narrower the beam, the lower the computational complexity. In addition, the beam width can be selected based on the targeted accuracy of the search. A very narrow beam can scan a database quickly, but it typically offers suboptimal retrieval accuracy. There can also be accuracy degradation when the beam width is set too wide. A proper beam width can facilitate accuracy and accommodate variances such as environmental noise, numerical noise, and the like. Beam searching enables multiple types of searches to be configured from a single database. For example, quick scans and detailed scans can be run on the same database depending on the beam width, as will be appreciated by the skilled artisan.

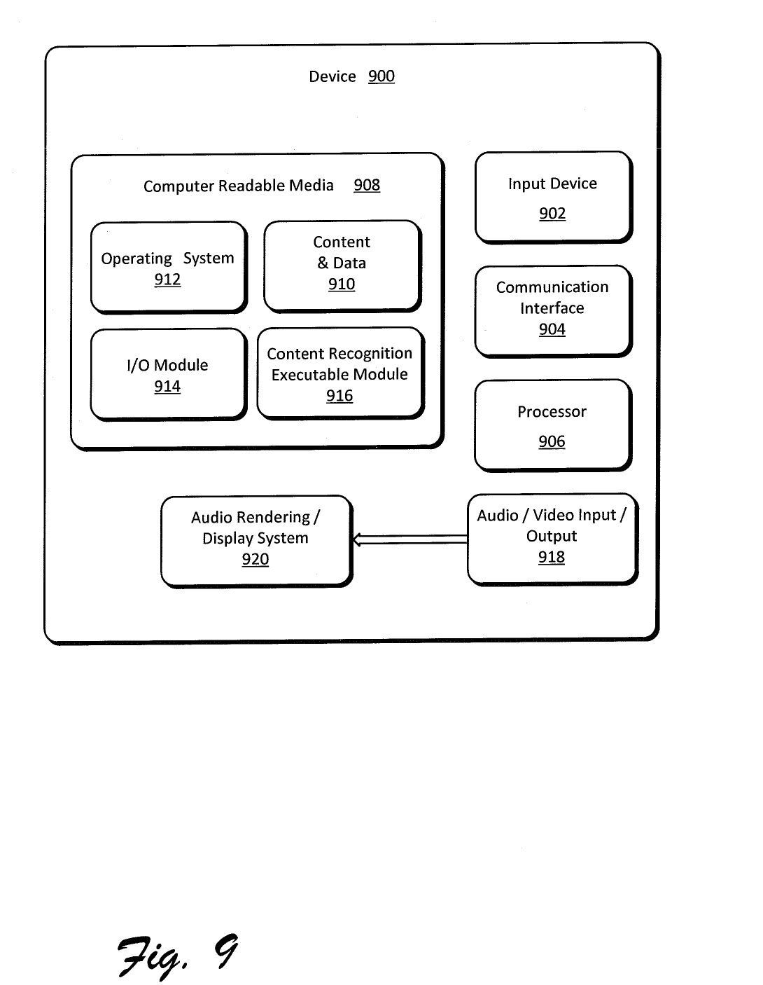

FIG. 8 depicts an example method 800 of capturing audio data by a mobile device for provision to a content recognition service, and determining a response to a query derived from the captured audio data. To that end, aspects of the method that are performed by the mobile device are designated “Mobile Device” and aspects of the method performed by the content recognition service are designated “Content Recognition Server.”

At block 805, audio data is captured by the mobile device. This can be performed in any suitable way, such as through the use of a microphone as described above.

Next, at block 810, the device stores the audio data in a buffer. This can be performed in any suitable way. In one or more embodiments, audio data can be continually added to the buffer, replacing previously stored audio data according to buffer capacity. For instance, the buffer may store the last five (5) minutes of audio, the last ten (10) minutes of audio, or the last hour of audio data depending on the specific buffer used and device capabilities.

At block 815, the device processes the captured audio data that was stored in the buffer at block 810 to extract features from the data. This can be performed in any suitable way. For example, in accordance with the example described just above, processing can include applying a Hamming window to the data, zero padding the data, transforming the data using FFT, and applying a log power. Processing of the audio data can be initiated in any suitable way, examples of which are provided above.

At block 820, the device generates a query packet. This can be performed in any suitable way. For example, in embodiments using spectral peak extraction for audio data processing, the generation of the query packet can include accumulating the extracted spectral peaks for provision to the content recognition server.

Next, at block 825, the device causes the transmission of the query packet to the content recognition server. This can be performed in any suitable way.

Next, at block 830, the content recognition server receives the query packet from the mobile device. At block 835, the content recognition server determines a beam width for use in searching a content database. The selected beam width can vary depending on the specific type of search to be performed and the selected accuracy rating for results. For example, for a quick search, the selected beam width can be narrower than the selected beam width for use in a detailed scan of the database, as will be appreciated by the skilled artisan.

At block 840, the content recognition server scans the content database for each peak in the query packet. This can be performed in any suitable way. For example, the content recognition server can extract the spectral peaks accumulated in the query packet into individual query peaks. Then, for each query peak, the content recognition server can scan the database using the selected beam width and retrieve a list of the time positions at the frequency index for that query peak. A score is incremented at the time differences between the database and query peaks. This procedure is repeated for each query peak in the query packet.

At block 845, the content recognition server assigns a content score to the query packet. This can be performed in any suitable way. For example, the content recognition server can select the highest incremented score for a query packet and assign that score as the content score.

Next, at block 850, the content recognition server compares the content score assigned at block 845 to the database and determines which content items in the database have the highest score. At block 855, the content recognition server returns content information associated with the highest content score to the mobile device. Content information can include, for example, a song title, song artist, the date the audio clip was recorded, the writer, the producer, group members, and/or an album title. Other information can be returned without departing from the spirit and scope of the claimed subject matter. This can be performed in any suitable way.

At block 860, the mobile device receives the information from the content recognition server. This can be performed in any suitable way. At block 865, the mobile device causes a representation of the content information to be displayed. The representation of the content information to be displayed can be album art (such as an image of the album cover), an icon, text, or a link. This can be performed in any suitable way.

Having described an example method of capturing audio data for provision to a content recognition service and determining a response to a query derived from the captured audio data in accordance with one or more embodiments, consider now a discussion of an example system that can be used to implement one or more embodiments.

Example System

FIG. 9 illustrates various components of an example client device 900 that can practice the embodiments described above. In one or more embodiments, client device 900 can be implemented as a mobile device. For example, device 900 can be implemented as any of the mobile devices 102 described with reference to FIG. 1. Device 900 can also be implemented to access a network-based service, such as a content recognition service as previously described.

Device 900 includes input device 902 that may include Internet Protocol (IP) input devices as well as other input devices, such as a keyboard. Device 900 further includes communication interface 904 that can be implemented as any one or more of a wireless interface, any type of network interface, and as any other type of communication interface. A network interface provides a connection between device 900 and a communication network by which other electronic and computing devices can communicate data with device 900. A wireless interface enables device 900 to operate as a mobile device for wireless communications.

Device 900 also includes one or more processors 906 (e.g., any of microprocessors, controllers, and the like) which process various computer-executable instructions to control the operation of device 900 and to communicate with other electronic devices. Device 900 can be implemented with computer-readable media 908, such as one or more memory components, examples of which include random access memory (RAM) and non-volatile memory (e.g., any one or more of a read-only memory (ROM), flash memory, EPROM, EEPROM, etc.).

Computer-readable media 908 provides data storage to store content and data 910, as well as device executable modules and any other types of information and/or data related to operational aspects of device 900. One such configuration of a computer-readable medium is signal bearing medium and thus is configured to transmit the instructions (e.g., as a carrier wave) to the hardware of the computing device, such as via the network 102. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data. The storage type computer-readable media are explicitly defined herein to exclude propagated data signals.

An operating system 912 can be maintained as a computer executable module with the computer-readable media 908 and executed on processor 906. Device executable modules can also include an I/O module 914 (which may be used to provide telephonic functionality) and a content recognition executable module 916 that operates as described above and below.

Device 900 also includes an audio and/or video input/output 918 that provides audio and/or video data to an audio rendering and/or display system 920. The audio rendering and/or display system 920 can be implemented as integrated component(s) of the example device 900, and can include any components that process, display, and/cm otherwise render audio, video, and image data. Device 900 can also be implemented to provide a user tactile feedback, such as vibrations and haptics.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware or a combination thereof. In the case of a software implementation, the module, functionality, or logic represents program code that performs specified tasks when executed on a processor (e.g., CPU or CPUs). The program code can be stored in one or more computer-readable memory devices. The features of the techniques described above are platform-independent, meaning that the techniques may be implemented on a variety of commercial computing platforms having a variety of processors.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

What is claimed is:

1. A computer-implemented method comprising:
capturing, using a computing device, audio data, at least some of which is processable for provision to a content recognition service, said capturing occurring prior to receiving user input associated with a request for information regarding the audio data;
formulating a query for submission to the content recognition service to identify displayable content information associated with the audio data;
transmitting the query to the content recognition service; and
receiving, from the content recognition service, displayable information associated with the audio data.

2. The method of claim 1 further comprising causing display of the displayable information associated with the audio data.

3. The method of claim 1, wherein the displayable information comprises one or more of a song title, an artist, an album title, a date an audio clip was recorded, a writer, a producer, or group members.

4. The method of claim 1, wherein capturing audio data comprises doing so prior to launch of an executable module associated with the content recognition service.

5. The method of claim 1, wherein capturing audio data comprises doing so prior to receiving user input via an executable module associated with the content recognition service.

6. The method of claim 1, wherein capturing audio data comprises doing so responsive to sensing a user interaction with the computing device.

7. The method of claim 1, wherein capturing audio data comprises doing so during execution of an executable module associated with the content recognition service, but prior to receiving user input via the executable module that information regarding the audio data is desired.

8. The method of claim 1, wherein formulating the query is performed responsive receiving user input via an executable module associated with the content recognition service.

9. The method of claim 1, wherein formulating the query comprises:
processing the audio data effective to extract spectral peaks from the audio data; and
accumulating extracted spectral peaks to formulate the query.

10. The method of claim 9, wherein processing the audio data comprises:
applying a Hamming window to the audio data;
zero padding audio data to which the Hamming window was applied;
transforming, using a fast Fourier transform, audio data to which zero padding was applied; and
applying a log power to audio data to which the fast Fourier transform was applied.

11. One or more computer-readable storage media comprising instructions that are executable to cause a device to perform a process comprising:
outputting a user interface that includes a representation of a user instrumentality configured to enable a user to request information regarding audio data captured by the device;
responsive to a selection of the representation of the user instrumentality, extracting a plurality of features from pre-buffered audio data to generate a query packet, the audio data being pre-buffered from a time prior to selection of the representation of the user instrumentality;
transmitting the query packet over a network to a server;
receiving, from the server, content information corresponding to the query packet; and
causing a representation of the content information to be displayed by the device.

12. The one or more computer-readable storage media of claim 11, the process further comprising:
capturing audio data, at least some of which is processable for provision to a content recognition service, prior to selection of the representation of the user instrumentality; and
continuously pre-buffering the audio data.

13. The one or more computer-readable storage media of claim 11, wherein the representation of the content information to be displayed comprises one or more of album art, an icon, text, or a link.

14. The one or more computer-readable storage media of claim 11, wherein the content information comprises one or more of a song title, an artist, a date an audio clip was recorded, a writer, a producer, group members, or an album title.

15. The one or more computer-readable storage media of claim 11, wherein extracting a plurality of features comprises:
processing the pre-buffered audio data effective to extract spectral peaks from the audio data.

16. The one or more computer-readable storage media of claim 15, wherein processing the pre-buffered audio data comprises:
applying a Hamming window to the pre-buffered audio data;
zero padding pre-buffered audio data to which the Hamming window was applied;
transforming, using a fast Fourier transform, pre-buffered audio data to which the zero padding was applied; and
applying a log power to pre-buffered audio data to which the fast Fourier transform was applied.

17. A mobile device comprising:
a microphone configured to capture audio data;
a background listening module configured to store captured audio data in a buffer prior to receiving a user input associated with a request for information regarding the audio data;
a feature extraction module configured to extract features from the audio data;
a query generation module configured to formulate a query packet for submission to a server to identify displayable information associated with the audio data;
an input/output module configured to transmit the query packet to the server and to receive, from the server, displayable information corresponding to the query packet; and
a display configured to display the displayable information.

18. The mobile device of claim 17, wherein the feature extraction module is configured to extract spectral peaks associated with the audio data.

19. The mobile device of claim 17, wherein the displayable information comprises one or more of a song title, an artist, a date an audio clip was recorded, a writer, a producer, group members, or an album title.

20. The mobile device of claim 17 further comprising an executable module configured to cause a user interface instrumentality to be presented to receive the user input associated with the request for information associated with the audio data.
